(19) United States
(12) Patent Application Publication
(10) Pub. No.: US 2021/0116577 A1
(43) Pub. Date: Apr. 22, 2021

(54) POSITIONING SYSTEM, POSITIONING DEVICE, AND CENTER DEVICE

(71) Applicant: DENSO CORPORATION, Kariya-city (JP)

(72) Inventors: Kiyoto NOGUCHI, Kariya-city (JP); Nobuyuki TAGUCHI, Kariya-city (JP); Takashi MURASE, Kariya-city (JP); Shigeki KAWAI, Kariya-city (JP)

(21) Appl. No.: 17/137,161

(22) Filed: Dec. 29, 2020

Related U.S. Application Data
(63) Continuation of application No. PCT/JP2019/022321, filed on Jun. 5, 2019.

(30) Foreign Application Priority Data
Jul. 4, 2018 (JP) 2018-127612

(51) Int. Cl. G01S 19/07

(52) U.S. Cl. CPC G01S 19/072

(57) ABSTRACT

A positioning system includes: multiple positioning devices: and a center device that communicates with each of the multiple positioning devices. At least one positioning device is usable at a moving body, and includes: a positioning calculator that calculates a location dependence delay amount and a propagation distance and calculates a current position of the at least one positioning device; and a positioning communication portion that transmits the location dependence delay amount. The center device includes: an update portion that updates a distribution location dependence delay amount; and a distribution communication portion that transmits the distribution location dependence delay amount to at least one of the multiple positioning devices.

### CROSS REFERENCE TO RELATED APPLICATIONS

The present application is a continuation application of International Patent Application No. PCT/JP2019/022321 filed on Jun. 5, 2019, which designated the U.S. and claims the benefit of priority from Japanese Patent Application No. 2018-127612 filed on Jul. 4, 2018. The entire disclosures of all of the above applications are incorporated herein by reference.

### TECHNICAL FIELD

The present disclosure relates to a positioning system, a positioning device including the positioning system, and a center device, and particularly relates to a technique of performing positioning by receiving a positioning signal transmitted by a positioning satellite and receiving the positioning signal.

### BACKGROUND

As a method for receiving a positioning signal and positioning a position, a precise point positioning method has been proposed. The precise point positioning method corrects an error amount such as a tropospheric delay amount. In a technique of a comparative example a center station calculates correction information such as the tropospheric delay amount by using a satellite signal collected by an electronic reference point. The center station uploads the correction information to a quasi-zenith satellite, and the quasi-zenith satellite distributes the correction information to the ground.

### SUMMARY

A positioning system may include: multiple positioning devices: and a center device that may communicate with each of the multiple positioning devices. At least one positioning device may be usable at a moving body, and include: a positioning calculator that may calculate a location dependence delay amount and a propagation distance and calculate a current position of the at least one positioning device; and a positioning communication portion that may transmit the location dependence delay amount. The center device may include: an update portion that may update a distribution location dependence delay amount; and a distribution communication portion that may transmit the distribution location dependence delay amount to at least one of the multiple positioning devices.

### BRIEF DESCRIPTION OF DRAWINGS

The above and other features and advantages of the present disclosure will be more clearly understood from the following detailed description with reference to the accompanying drawings. In the accompanying drawings,

FIG. 1 is a diagram showing an overall configuration of a positioning system;

FIG. 2 is a diagram showing a configuration of a positioning device;

FIG. 3 is a diagram showing a configuration of a center device;

FIG. 4 is a diagram showing a structure of a set of correction information;

FIG. 5 is a diagram showing a structure of upload data uploaded by the positioning device;

FIG. 6 is a diagram showing a structure of download data downloaded by the positioning device;

FIG. 7 is a diagram showing a data structure of a download request;

FIG. 8 is a diagram showing a data structure of an upload request;

FIG. 9 is a diagram showing a structure of correction information estimation data;

FIG. 10 is a diagram showing the structure of the correction information database;

FIG. 11 is a diagram illustrating an area to which one correction information is applied;

FIG. 12 is a flowchart showing processes executed by a calculator of the positioning device;

FIG. 13 is a flowchart showing processes that are subsequent to FIG. 12 and are executed by the calculator;

FIG. 14 is a flowchart showing a process of S1 in FIG. 12 in detail;

FIG. 15 is a flowchart showing a process of S4 in FIG. 12 in detail;

FIG. 16 is a flowchart showing a process of S8 in FIG. 12 in detail;

FIG. 17 is a flowchart showing a process of S9 in FIG. 12 in detail;

FIG. 18 is a flowchart showing a process of S10 in FIG. 13 in detail;

FIG. 19 is a flowchart showing a process of S12 in FIG. 13 in detail;

FIG. 20 is a flowchart showing a process of S13 in FIG. 13 in detail;

FIG. 21 is a flowchart showing a process of S131 in FIG. 20 in detail;

FIG. 22 is a flowchart showing a process of S132 in FIG. 20 in detail;

FIG. 23 is a flowchart showing processes executed by the calculator of the positioning device in parallel with FIGS. 12 and 13.

FIG. 24 is a flowchart showing an upload data related process executed by a calculator of a center device;

FIG. 25 is a flowchart showing a download data related process executed by the calculator of the center device; and

FIG. 26 is a flowchart showing an upload request related process executed by a calculator of the center device.

### DETAILED DESCRIPTION

The tropospheric delay amount is a value that changes depending on a location. The correction information includes an ionospheric delay amount. The ionospheric delay amount also changes depending on the location. In the comparative example, these delay amounts are calculated based on the satellite signal collected by an electronic reference point. Accordingly, in the comparative example, it is necessary to arrange the electronic reference points densely in order to improve the positioning accuracy. However, when the number of electronic reference points are increased for densely increasing the electronic reference points, the cost increases.

One example of the present disclosure provides a positioning system, a positioning device including the positioning system, and a center device capable of performing high precision positioning while preventing the number of electronic reference points from increasing.

According to one example embodiment, a positioning system includes multiple positioning devices and a center device that communicates with the plurality of positioning devices. Each of the multiple positioning devices can be used at a moving body and includes: a positioning calculator that calculates a location dependence delay amount and a propagation distance as a convergence value of an observation equation including, as a parameter, the propagation distance and the location dependence delay amount including at least one of a tropospheric delay amount or an ionospheric delay amount and calculates a current position based on the propagation distance; and a positioning communication portion that transmits the location dependence delay amount calculated by the positioning calculator to the center device together with a position. The center device includes: an update portion that updates a distribution location dependence delay amount based on the location dependence delay amount transmitted by the each of the multiple positioning devices; and a distribution communication portion that transmits the distribution location dependence delay amount updated by the update portion to at least one of the multiple positioning devices.

In this positioning system, the positioning device calculates the location dependence delay amount as the convergence value of the observation equation including, as the parameter, the location dependence delay amount and the propagation value. This location dependence delay amount is transmitted to the center device together with the position. Since the positioning device can be used in a moving object, unlike the electronic reference point, the positioning device can be mounted in the moving body such as the vehicle requiring the positioning and can be used for sequentially positioning the position of the moving object. Therefore, the number of positioning devices can be easily set to be higher than the number of electronic reference points. By increasing the number of positioning devices 100, it may be possible to increase the number of places for observing the location dependence delay amount. When the number of places for observing the location dependence delay amount can be increased, the location dependence delay amount can be updated for each narrower area. Accordingly, it may be possible to provide the highly precise positioning while preventing the number of electronic reference points from increasing.

According to another example embodiment, a positioning device can be used at a moving body and includes: a positioning calculator that calculates a location dependence delay amount and a propagation distance as a convergence value of an observation equation including, as a parameter, the propagation distance and the location dependence delay amount including at least one of a tropospheric delay amount or an ionospheric delay amount and calculates a current position based on the propagation distance; and a positioning communication portion that transmits the location dependence delay amount calculated by the positioning calculator to the center device together with a position.

Further, another example embodiment, a center device communicates with a plurality of positioning devices. The center device includes: an update portion that updates a distribution location dependence delay amount including at least one of a tropospheric delay amount or an ionospheric delay amount based on the location dependence delay amount transmitted by the each of the multiple positioning devices; and a distribution communication portion that transmits the distribution location dependence delay amount updated by the update portion to at least one of the multiple positioning devices.

The positioning device and the center device are a positioning device and a center device in the positioning system.

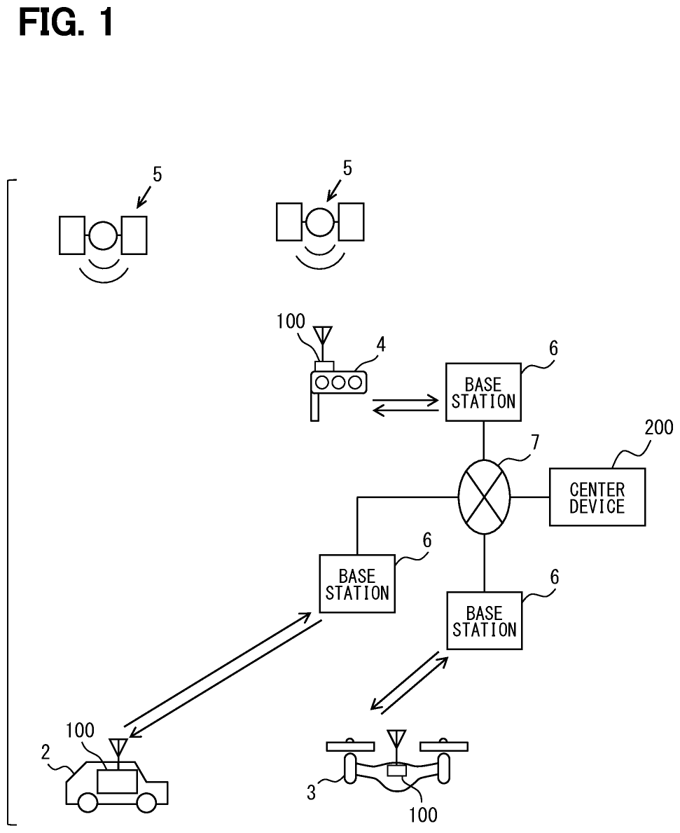

Hereinafter, an embodiment will be described with reference to the drawings. FIG. 1 is a diagram showing an overall configuration of a positioning system 1 according to the embodiment.

(Overall Configuration)

The positioning system 1 includes a positioning device 100 and a center device 200. The positioning devices 100 are attached to various objects. In FIG. 1, among the positioning devices 100, the first positioning device 100 is mounted on a vehicle 2, the second positioning device 100 is mounted on a drone 3, the third positioning device 100 is fixed to a traffic light 4. In such a manner, the positioning device 100 may be attached to a moving object such as the vehicle 2 or the drone 3, and may be fixed to a stationary object such as the traffic light 4. Although FIG. 1 shows the three positioning devices 100, the number of positioning devices 100 are not limited. A large number of moving bodies and stationary bodies can include the positioning device 100.

The positioning device 100 receives a satellite signal transmitted by a positioning satellite 5, and sequentially calculates a position of an own device based on the satellite signal. A calculation method used when the own device position is calculated is similar to a method called the precise point positioning, and corrects the tropospheric delay amount. In addition to the tropospheric delay amount, an ionospheric delay amount may be corrected. The positioning satellite 5 is a satellite of a satellite positioning system such as GPS, GLONASS, Galileo, IRNSS, QZSS, or Beidou.

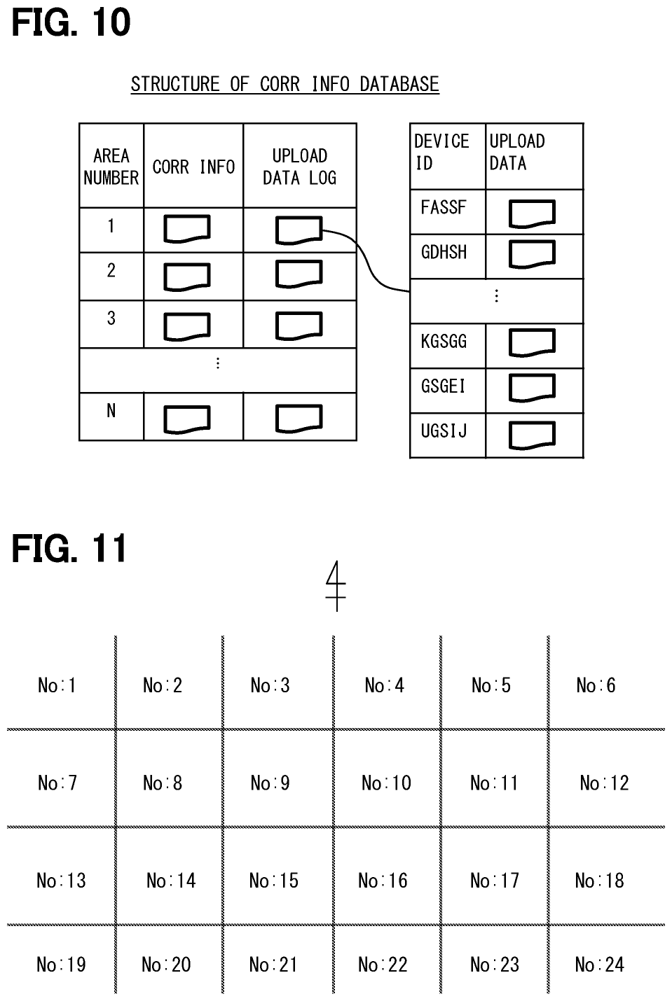

The positioning device 100 and the center device 200 can communicate with each other via a base station 6 placed on the ground and a public communication network 7. Correction information including a delay amount is provided from the center device 200 to the positioning device 100. In the drawings, the correction information may be also referred to as “CORR INFO”. The positioning device 100 estimates an error that fluctuates depending on a location such as a tropospheric delay error concurrently with the positioning at the time of the precise point positioning. A method for estimating the tropospheric delay error is a method for converging an equation value of the delay amount by using an observation equation including the delay amount as a parameter. The positioning device 100 transmits the correction information including the estimated delay amount to the center device 200. The center device 200 can update the correction information stored in a correction information database (see FIG. 10) based on the correction information received from the positioning device 100.

(Configuration of Positioning Device)

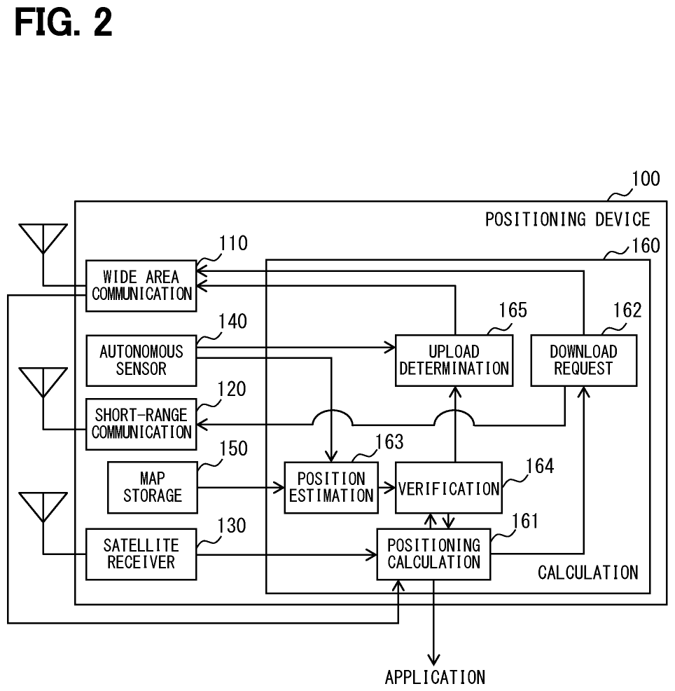

A configuration of the positioning device 100 will be described with reference to FIG. 2. The positioning device 100 includes a wide area communication portion 110, a short range communication portion 120, a satellite receiver 130, an autonomous sensor 140, a map storage 150, and a calculator 160.

The wide area communication portion 110 is one of positioning communication portions, and wirelessly communicates with the center device 200 via the base station 6 and the public communication network 7. For example, LTE can be adopted as the communication method.

The short range communication portion 120 is a communication portion that wirelessly communicates with another short range communication portion 120 existing around this positioning device 100. The communication range of the short range communication portion 120 is, for example, about several hundred meters.

The satellite receiver 130 receives the satellite signal transmitted by the positioning satellite 5, and outputs observation data. The observation data is, for example, a pseudo distance or a carrier phase. The observation data may include a CN (carrier-to-noise) ratio, satellite orbit information, or the like.

The autonomous sensor 140 is a camera or a LiDAR that captures the periphery of the positioning device 100, and includes at least one sensor that estimates a current position by using a high precision map.

The map storage 150 stores the high precision map. The high precision map is a map that represents road markings such as road lane markings and three dimensional objects around the road such as road signs, or buildings.

The calculator 160 can be implemented by, for example, a computer including a CPU, a ROM, a RAM, an I/O, a bus line connecting those components, and the like. The ROM stores a program for causing a general-purpose computer to function as the calculator 160. When the CPU executes a program stored in the ROM while using the temporary storage function of the RAM, the calculator 160 functions as a positioning calculator 161, a download request portion 162, a position estimation portion 163, a verification portion 164, and an upload determiner 165. When these functions are executed, a method corresponding to the program is executed.

Next, the functions of the calculator 160 will be schematically described. The functions of the calculator 160 will be described later in detail with reference to a flowchart.

The positioning calculator 161 positions the current position based on the observation data provided from the satellite receiver 130 and the correction information acquired via the wide area communication portion 110. The positioning calculator 161 estimates the delay amount including the tropospheric delay amount when positioning the current position. The positioning calculator 161 may calculate the speed from a time change of the current position in addition to the positioning of the current position. The positioning calculator 161 outputs the calculated information such as the current position to an application. When the positioning device 100 is mounted on the vehicle 2, the application is, for example, a driving support application, an automatic driving application, or a parking support application.

The download request portion 162 determines whether it is necessary to download the correction information used for the positioning calculation by the positioning calculator 161. When it is determined that the download is necessary, a download request for requesting transmission of the correction information is transmitted from the wide area communication portion 110 to the center device 200.

The position estimation portion 163 estimates the current position by collating a peripheral situation of the positioning device 100 with the high precision map. The peripheral situation is detected by the autonomous sensor 140. This current position is used for the verification portion 164 described below Accordingly, the position estimation portion 163 estimates the current position at a timing when the verification by the verification portion 164 can be provided. The position estimation portion 163 can also continuously estimate the current position.

The verification portion 164 verifies whether the delay amount estimated by the positioning calculator 161 at the time of positioning the current position is correct by comparing the current position calculated by the positioning calculator 161 with the current position estimated by the position estimation portion 163. When it is determined that the delay amount is not correct, the delay amount calculated by the positioning calculator 161 and the current position are set to values indicating that the solution is not correct.

The upload determiner 165 determines whether the correction information including the delay amount should be uploaded based on a verification result obtained by the verification of the verification portion 164. When the correction information should be uploaded, the upload data including the correction information is transmitted from the wide area communication portion 110 to the center device 200.

(Configuration of Center Device)

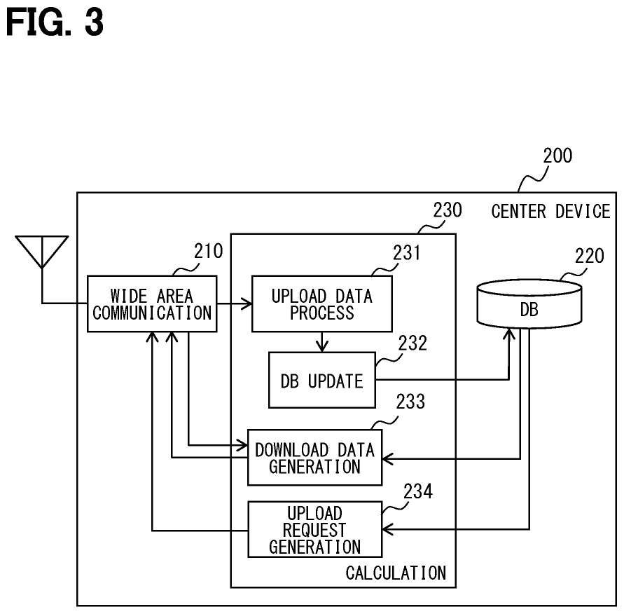

FIG. 3 shows a configuration of the center device 200. The center device 200 includes a wide area communication portion 210, a database storage 220, and a calculator 230. The wide area communication portion 210 is a communication portion for wirelessly communicating with the positioning device 100, and corresponds to a distribution communication portion. The database storage 220 stores the correction information database.

The calculator 230 can be implemented by, for example, a computer including a CPU, a ROM, a RAM, an I/O, a bus line connecting those components, and the like. The ROM stores a program for causing a general-purpose computer to function as the calculator 230. When the CPU executes a program stored in the ROM while using the temporary storage function of the RAM, the calculator 230 functions as an upload data processing portion 231, a database upload portion 232, a download data generation portion 233, and an upload request generation portion 234. When these functions are executed, a method corresponding to the program is executed.

Next, the functions of the calculator 230 will be schematically described. The functions of the calculator 230 will be described later in detail with reference to a flowchart. The upload data processing portion 231 executes a determination process of determining whether the correction information uploaded from the positioning device 100 is correction information of which correction information database should ne updated, and executes an ID assignment process. The database upload portion 232 updates the correction information for distribution based on the upload data that is sequentially uploaded. The correction information for the distribution is stored in the correction information database every upload cycle.

The download data generation portion 233 acquires the request from the wide area communication portion 210 when the download request of the correction information is transmitted from the positioning device 100. The download data generation portion 233 generates the download data decided based on the download request, and the download data is transmitted from the wide area communication portion 210 to the positioning device 100 that has transmitted the download request. The download data structure will be described later with reference to FIG. 6.

The upload request generation portion 234 transmits the upload request indicating the data to be updated from the wide area communication portion 210 when it is determined that the correction information database should be updated.

(Structure of Correction Information)

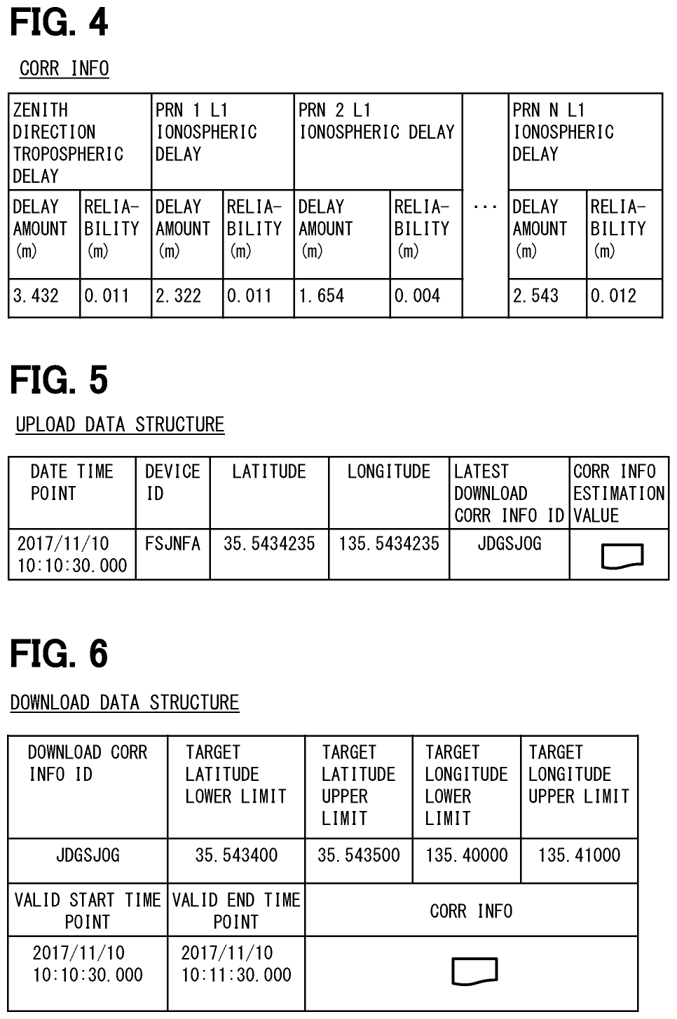

FIG. 4 shows a structure of a set of correction information. The correction information of the present embodiment is a structure including a zenith direction tropospheric delay and the ionospheric delay. Each delay includes the delay amount and a reliability. The reliability is, for example, a positive value meaning that the precision of the corresponding delay amount is 1 meter at 1 σ when the reliability is 1 meter. The PRNn (n is a natural number) is a PRN number, and the PRN is a pseudo random noise. The L1 means a L1 signal in GPS. Since a different PRN is used for each positioning satellite 5, the PRNn distinguishes the positioning satellites 5.

(Upload Data Structure)

FIG. 5 shows a structure of data (hereinafter, upload data) uploaded by the positioning device 100. The upload data includes an upload date, an upload time point, a device ID of the positioning device 100 uploading the data, a latitude and a longitude where the positioning device 100 is positioned, a latest download correction information ID, and a correction information estimation value. The latest download correction information ID is an ID that identifies the latest correction information among the correction information download from the center device 200. The correction information estimation value has a structure shown in FIG. 4.

(Download Data Structure)

FIG. 6 shows a configuration of download data that is generated by the center device 200 and is downloaded by the positioning device 100. The download data includes a download correction information ID, a target latitude lower limit, a target latitude upper limit, a target longitude lower limit, a target latitude upper limit, a valid start time point, a valid end time point, and correction information. The correction information is a location dependence delay amount for the distribution. Accordingly, the download data includes the location dependence delay amount for the distribution.

The download correction information ID is an ID assigned to the download data each time the center device 200 generates the download data. The target latitude lower limit is a lower limit of the latitude at which the correction information can be used, and the target latitude upper limit is an upper limit of the latitude at which the correction information can be used. The target longitude lower limit is a lower limit of the longitude at which the correction information can be used, and the target longitude upper limit is an upper limit of the longitude at which the correction information can be used. Since values of the tropospheric delay amount and the ionospheric delay amount in the correction information differ depending on a positioning region, the upper limits and the lower limits of the latitude and the latitude where the correction information can be used are set.

The valid start time point is a start time point at which the correction information can be used, and the valid end time point is an end time point at which the correction information can be used. The ionospheric delay amount and the tropospheric delay amount change with the passage of time. Therefore, the start time point and the end time point at which the correction information can be used are set.

(Download Request Data Structure)

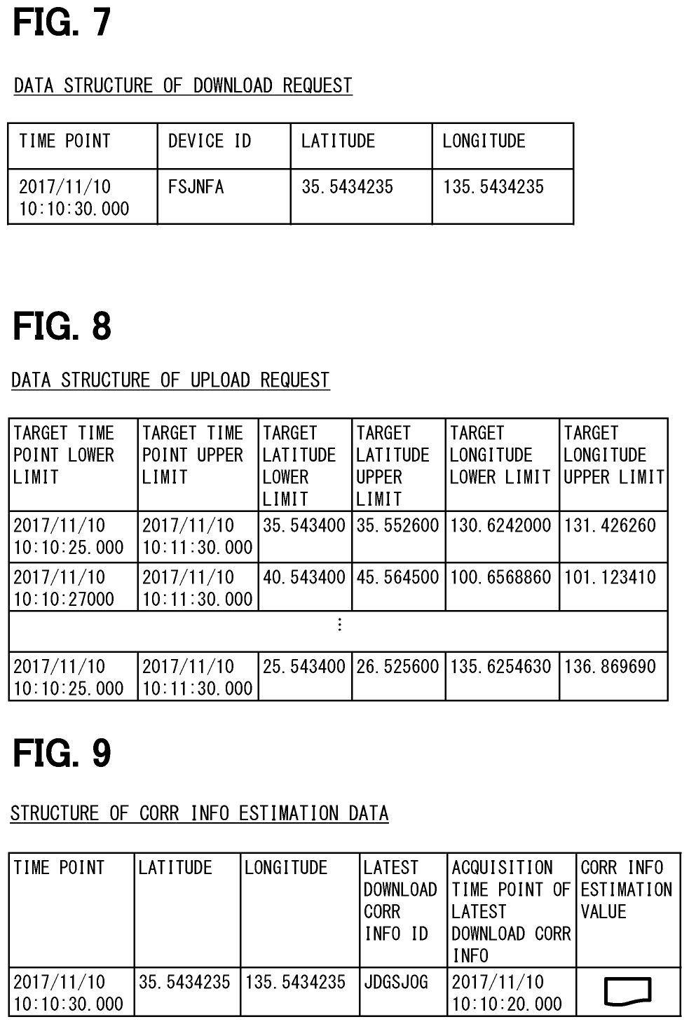

FIG. 7 shows a data structure of the download request transmitted by the positioning device 100 to the center device 200. As described above, the download request requests the download of the correction information. The download request includes a request time point, the device ID of the positioning device 100, a latitude representing the current position of the positioning device 100, and a longitude.

(Data Structure of Upload Request)

FIG. 8 shows a data structure of the upload request transmitted by the center device 200 to the positioning device 100. The upload request requests the upload of the correction information. The upload request includes a target time point lower limit, a target time point upper limit, a target latitude lower limit, a target latitude upper limit, a target longitude lower limit, and a target longitude upper limit.

The target time point is a time point when the positioning device 100 estimates the correction information. As described with reference to FIG. 6, the correction information downloaded by the positioning device 100 has a valid period. Therefore, a lower limit and an upper limit are also set for a time point when the correction information requesting the upload is estimated. Since the value of the correction information differs depending on the positioning region, the lower limit and the upper limit are set for the target latitude and the target longitude.

The data for one line shown in FIG. 8 is a set of data for one area for which the upload is requested. The upload request includes a number of data sets in accordance with the number of areas for which the upload of the correction information is requested.

When receiving the upload request, the positioning device 100 stores the upload request until the upper limit of the target time point. However, when the new upload request is received before the upper limit of the target time point, the saved upload request is overwritten with the newly received upload request.

(Data Structure of Correction Information in Positioning Device)

FIG. 9 shows a structure of the correction information estimation data stored by the positioning device 100. The positioning device 100 stores the correction information in a predetermined memory with use of the structure shown in FIG. 9 As the memory, a flash memory or the like in the calculator 160 can be used. The memory may be provided outside the calculator 160.

The correction information estimation data includes the time point, the latitude, the longitude, the latest download correction information ID, a time point when the latest download correction information ID is acquired, and the correction information estimation value, Here, after the positioning, the correction information estimation value is the correction information estimated by the positioning. Before the positioning, the correction information estimation value is the downloaded correction information. The correction information has the structure shown in FIG. 4. The time point is a time point when the correction information estimation value is updated. The latitude and the longitude indicate a position when the correction information estimation value is updated.

The positioning device 100 generates the correction information estimation data shown in FIG. 9 every time the correction information estimation value is updated. The new correction information estimation data is generated, and thereby the correction information estimation data that is no longer the latest is not discarded and saved as correction information log data. The correction information log data has a structure in which the correction information estimation data is sequentially recorded, as shown in FIG. 9.

(Structure of Correction Information Database in Center Device)

FIG. 10 shows a structure of the correction information database stored in the database storage 220 of the center device 200. The correction information database includes, as attributes, an area number, the correction information, an upload data log.

The area number is a number for identifying the area to which one correction information is applied. The size of one area is set to a size where the same correction information can be used. As a simple example, as shown in FIG. 11, each area can be set to a rectangular area obtained by dividing a terrain by lines at regular intervals in the latitude direction and the longitude direction. However, as another example, the areas may overlap each other, and the size of area may be different for each area.

The correction information is the distribution correction information to be distributed to the positioning device 100. The distribution correction information is sequentially updated with use of the correction information uploaded from one or more positioning devices 100. A structure of the distribution correction information is same as that shown in FIG. 4. When the multiple positioning devices 100 upload the correction information estimation values for the same area, the distribution correction information is updated by averaging the correction information estimation values within the valid period or the like.

The upload data log includes the upload data that is uploaded from the positioning device 100 and shown in FIG. 5. The maximum number of upload data saved as the upload data log is N. The N is a positive integer. FIG. 10 shows the device ID in addition to the upload data so that it can be understood that each upload data is data uploaded from each positioning device 100 based on the figure. However, as shown in FIG. 5, the device ID is included in the upload data.

(Process Executed by Calculator of Positioning Device)

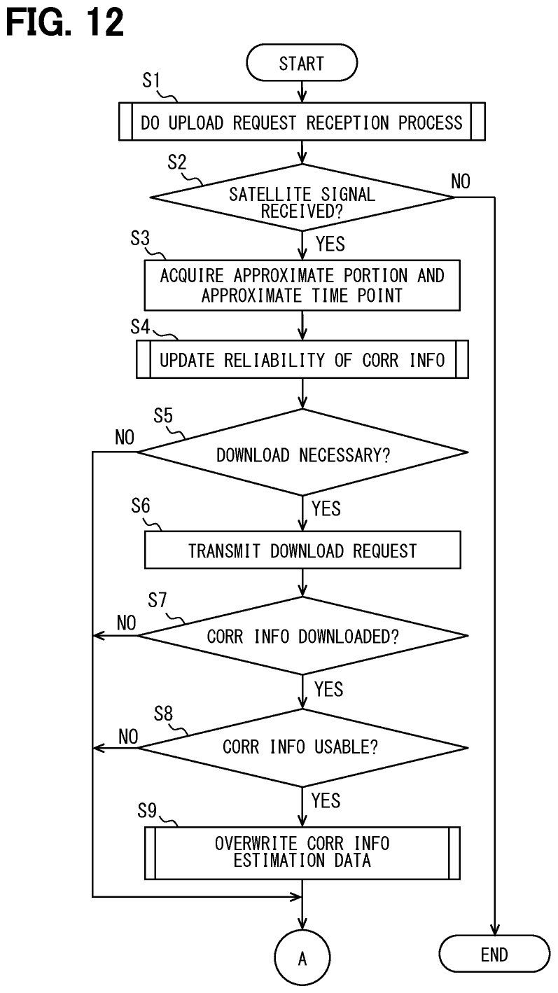

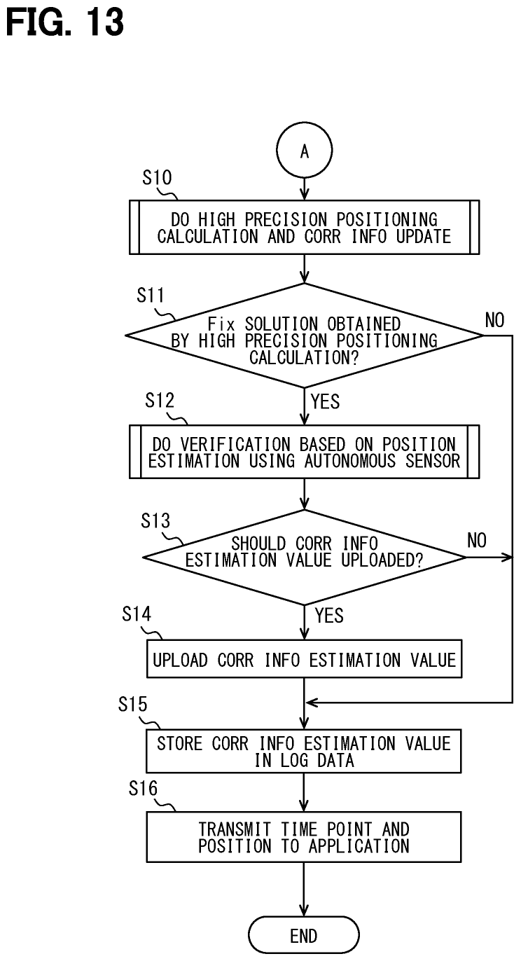

The calculator 160 of the positioning device 100 periodically executes processes shown in FIG. 12 and FIG. 13. S1 to S4, S10, S15, and S16 are processes executed by the positioning calculator 161. S5 to S9 are processes executed by the download request portion 162. S11 and S12 are processes executed by the verification portion 164. S13 and S14 are processes executed by the upload determiner 165.

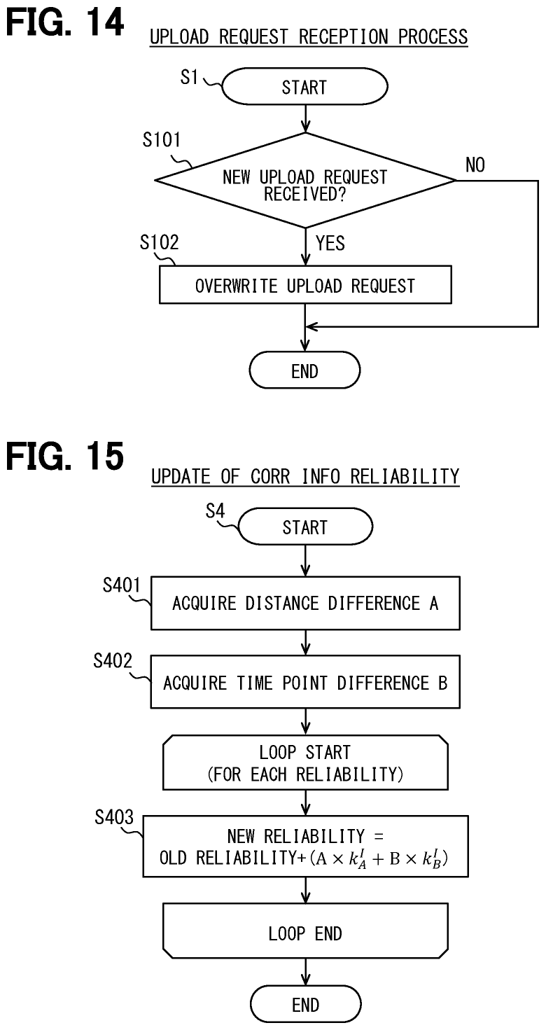

In S1, an upload request reception process is executed. This process is the process shown in FIG. 14. In FIG. 14, in S101, it is determined whether the new upload request is received from the center device 200. The upload request is shown in FIG. 8. When the determination is Yes in S101, the process shifts to S102. When the determination is No in S101, the process in FIG. 14 ends and the process in S2 of FIG. 12 starts.

In S102, the stored upload request is overwritten by the received upload request. After the execution in S102, the process shifts to S2 in FIG. 12.

In S2 of FIG. 12, it is determined whether a number of satellite signals for which a pseudo distance can be calculated is received. When this determination is No, the process of FIG. 12 ends. In this case, after a certain period, S1 is executed again. On the other hand, when the determination is YES in S2, the process shifts to S3.

In S3, an approximate position and an approximate time point are acquired by the pseudo distance positioning. In the pseudo distance positioning, the pseudo distance is calculated by multiplying a propagation time of the satellite signal by the speed of light. A coordinate of the positioning device 100 and a timepiece error are obtained by solving an equation including four unknown variables that are the coordinate of the positioning device 100 and a clock error. This coordinate is the approximate position, and the time point when a time piece of the satellite receiver 130 is corrected due to the time piece error is the approximate time point.

In S4, the reliability in the correction information is updated based on the approximate position and the approximate time point that are acquired in S3. Since the reliability changes depending on the change amounts of the time point and the position, the process in S4 is executed. FIG. 15 shows the details of S4.

In FIG. 15, in S401, an Euclidean distance (hereinafter, distance difference A) between a position (that is, latitude and longitude) indicated by the latest correction information log data stored by the positioning device 100 and the approximate position. In S402, a difference (hereinafter, time point difference B) between the time point indicated by the latest correction information log data and the approximate time point is acquired.

S403 is a process executed for each reliability, and a new reliability is calculated. The reliability in the correction information estimation value is set to this new reliability. In S403, the new reliability is calculated from an equation 1 below. In the equation 1, the i is a loop number. The KAi and KBi are weighting coefficients set in consideration of the influence of the distance difference A and the time point difference B that are provided to the reliability, and are values set in advance at the time of shipment or the like. The weighting coefficients KAi and KBi are positive real numbers.

new reliability=old reliability+(A×KAi+B×KBi) (Equation 1)

The new reliability calculated by this equation 1 is larger as the distance difference A and the time point difference B are larger. The unit of reliability is meters. As the value of the reliability is larger, the variation in the delay amount becomes larger. In other words, as the value of the reliability is larger, the reliability is lower. As the reliability value is smaller, the variation in the delay amount becomes smaller. In other words, as the reliability value is smaller, the reliability is higher.

The description is returned to FIG. 12. In S5, it is determined whether the download of the correction information is necessary. In this S5, in detail, it is determined that the reliability for the delay amount is higher than a threshold value, the delay amount being used for the precise positioning calculation among the delay amounts in the correction information estimation value stored by the positioning device 100. The delay amount for the precise positioning calculation is a tropospheric delay amount and an ionospheric delay amount in accordance with the ionospheric delay amount and the observable satellite signal. When there is even one delay amount satisfying the condition, it is determined that the download of the correction information is necessary. On the other hand, there is no delay amount satisfying the condition, it is determined that the download of the correction information is not necessary. In the drawings, the threshold value may be also referred to as “TH VALUE”.

When the determination in S5 is Yes, the process shifts to S6. In S6, the download request requesting the download of the correction information is transmitted to the center device 200. The data structure of the download request is the structure shown in FIG. 7.

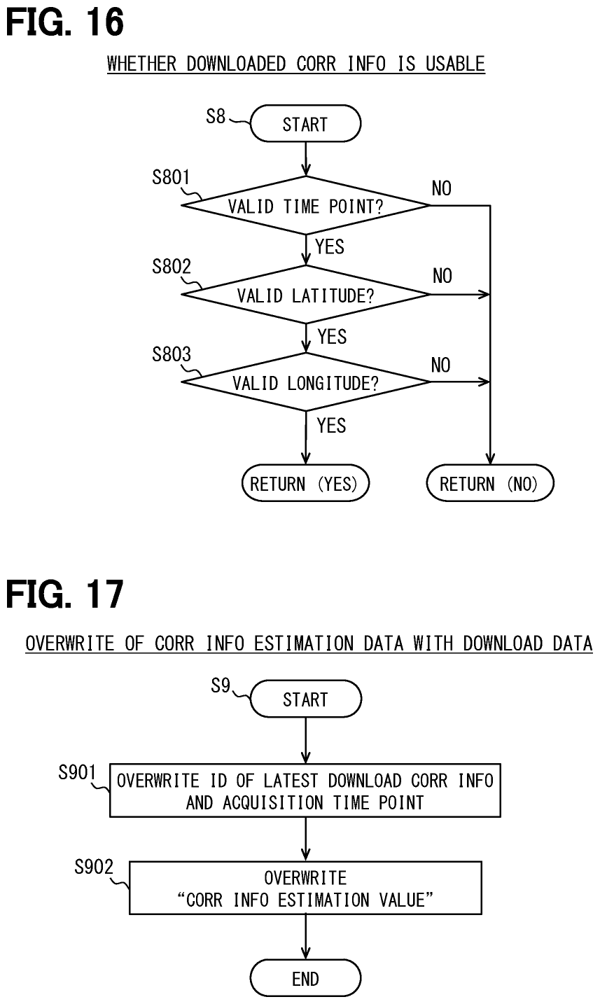

In S7, it is determined whether the correction information has been downloaded. When the determination in S7 is Yes, the process shifts to S8. When the determination in S7 is No, the process shifts to S10 of FIG. 13. In S8, it is determined whether the downloaded correction information is usable. For this determination, in detail, processes shown in FIG. 16 are executed.

In FIG. 16, in S801, it is determined whether the time point is valid. The download data downloaded from the center device 200 includes the lower limit and the upper limit of the target latitude and the lower limit and the upper limit of the target longitude, the valid start time point, and the valid end time point, as shown in FIG. 6. Whether the time point is valid is determined based on whether the current time point is between the valid start time point and the valid end time point in the download data.

When the determination in S801 is No, the determination in S8 is No. In this case, the process shifts to S10 of FIG. 13. When the determination in S801 is Yes, the process shifts to S802. In S802, it is determined that the latitude is valid. Whether the latitude is valid is determined based on whether the current latitude is between the target latitude lower limit and the target latitude upper limit in the download data. When the determination in S802 is No, the determination in S8 is No.

When the determination in S802 is Yes, the process shifts to S803. In S803, it is determined whether the longitude is valid. Whether the longitude is valid is determined based on whether the current longitude is between the target longitude lower limit and the target longitude upper limit in the download data. When the determination in S803 is No, the determination in S8 is No. When the determination in S803 is Yes, the determination in S8 is Yes. When the determination in S8 is Yes, the process shifts to S9.

In S9, the process shown in FIG. 17 is executed, and the correction information estimation data stored in the positioning device 100 is overwritten with the download data. In FIG. 17, in S901, the latest download correction information ID in the correction information estimation data is overwritten with the download correction information ID in the download data downloaded this time. The time point when the latest download correction information is acquired in the correction information estimation data is overwritten with the download time point downloaded this time. In S902, the correction information estimation value in the correction information estimation data is overwritten with the correction information in the download data downloaded this time.

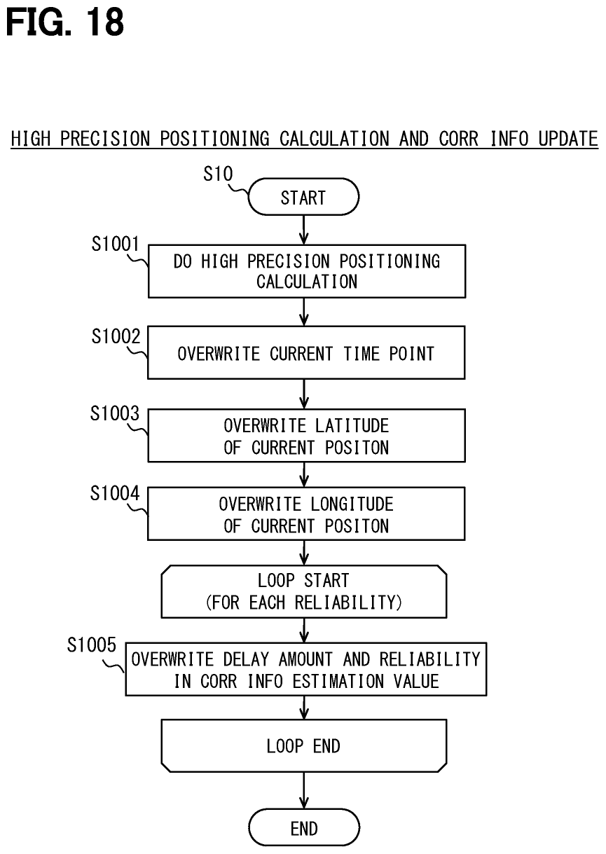

Next, S10 and subsequent processes shown in FIG. 13 will be described. In S10, the high precision positioning calculation is performed. The high precision positioning calculation is sometimes called a PPP (precise point positioning) method. FIG. 18 shows a process of S10 in detail.

In S1001 in FIG. 18, the high precision positioning calculation is performed using the correction information estimation value. The high precision positioning calculation is a method for calculating the current position based on a phase difference of the carrier wave phase, and can be performed by the same method as that described in Patent Literature 1 of JP 2015-125119 A. Patent Literature 1 is incorporated herein by reference. In Patent Literature 1, a geometric distance between the positioning satellite antenna and the reception antenna, that is, a propagation distance of an observation signal is calculated by solving an observation equation including, as parameters, an ionospheric propagation delay (ionospheric delay amount of the present disclosure) and a tropospheric propagation delay (tropospheric delay amount of the present embodiment). The current position is calculated by using this geometric distance and an equation expressing the geometric distance with use of the satellite antenna coordinate and the reception antenna coordinate.

Further, Patent Literature 1 discloses a method for calculating the current position as an observation equation that does not include the ionospheric propagation delay by receiving the observation signals of two kinds of frequencies and removing the influence of the ionospheric delay. In either method, when one of the ionospheric propagation delay and the tropospheric propagation delay is included as the parameter or both are included as parameters, the convergence value is calculated by continuous observation. Also in the high precision positioning calculation, similarly to the pseudo distance positioning, the timepiece error can be obtained.

In S1002, the timepiece (that is, current time point) of the positioning device 100 is corrected based on the timepiece error acquired in S1001.

In S1003, the latitude of the current position is overwritten with the latitude acquired in S1001. In S1004, the longitude of the current position is overwritten with the longitude acquired in S1001.

S1005 is a process executed for each delay amount in the correction information estimation value, and the delay amount and the reliability are overwritten. The delay amount is, specifically, the tropospheric delay amount and the ionospheric delay amount, and obtained by the high precision positioning calculation of S1001. The reliability is the maximum variation of each delay amount until the convergence value is obtained.

The description is returned to FIG. 13. In S11, it is determined whether a Fix solution is obtained by the high precision positioning calculation. In the high precision positioning calculation, an integer value bias is determined. However, the integer value bias cannot be decided to the integer value, and the integer value bias may be an approximate solution including a fractional value. In this S11, it is determined whether the integer value is obtained as the integer value bias. It is called a Fix solution that the solution of the integer value bias is the integer value. When the Fix solution is obtained, the positioning result is highly precise.

When the determination in S11 is Yes, the process shifts to S12. When the determination in S11 is No, the process shifts to S15. In S12, the verification by the position estimation using the autonomous sensor 140 is performed. Even when it is determined that the Fix solution is obtained by the high precision positioning and the highly precise positioning result is obtained, the positioning error may exist. Then, since there is the possibility that the delay amount in the correction information estimation value also includes the delay amount, the verification is performed.

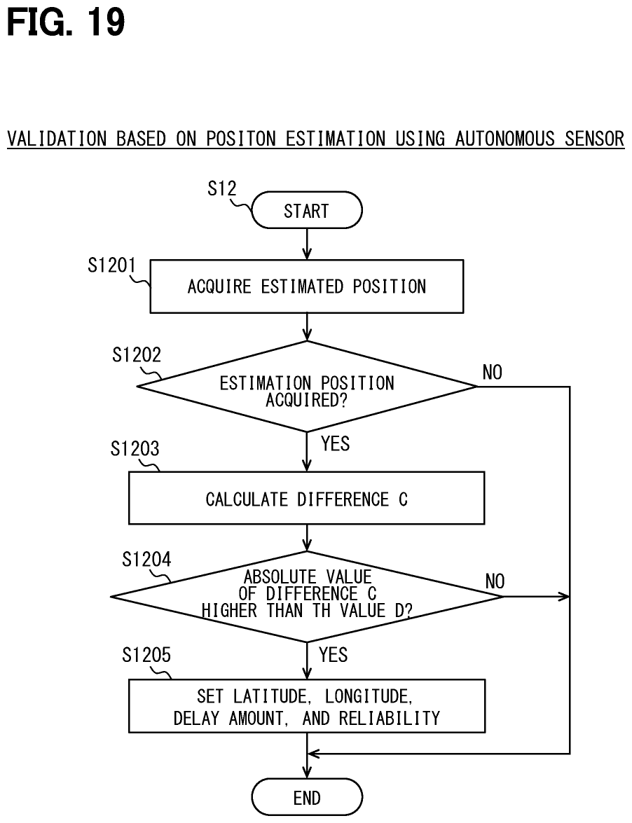

In S12, in detail, processes shown in FIG. 19 are executed. In FIG. 19, in S1201, the current position estimated by the position estimation portion 163 with use of the autonomous sensor 140 and the high precision map is acquired.

In S1202, it is determined whether the estimation position has been acquired. When the determination is NO, the process shown in FIG. 19 ends. On the other hand, when the determination is YES in S1202, the process shifts to S1203. In S1203, a difference C between the position obtained by the high precision positioning and the position estimated by the position estimation portion 163 is calculated.

In S1204, it is determined whether the absolute value of the difference C is higher than a preset threshold value D. The threshold value D is a positive real number. When the difference C is large, either the position obtained by the high precision positioning or the position estimated by the position estimation portion 163 with use of the autonomous sensor 140 and the high precision map may include the error.

When the determination in S1204 is No, the process of FIG. 19 ends. When the determination in S1204 is Yes, the process shifts to S1205. In S1205, the latitude indicating the current position, the longitude indicating the current position, the delay amount in the correction information estimation value, and the reliability in the correction information estimation value are rewritten into constants. The latitude, the longitude, and the delay amount are set to a value indicating that the solution is not normal, for example, Nan values. The reliability is set to a predetermined positive real number.

The description is returned to FIG. 13. In S13, it is determined whether the correction information estimation value should be uploaded. Even when the correction information estimation value is updated, it is not always necessary to upload the correction information estimation value. Therefore, in this S13, it is determined whether the correction information estimation value should be uploaded.

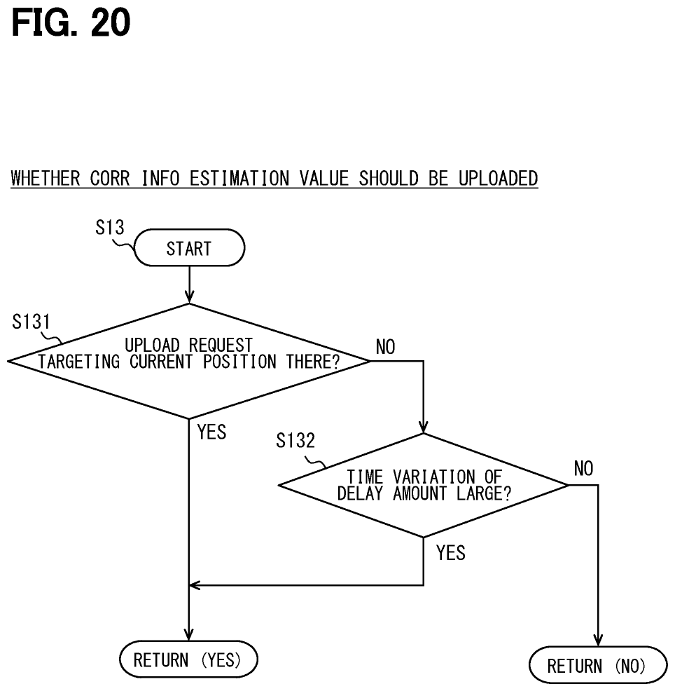

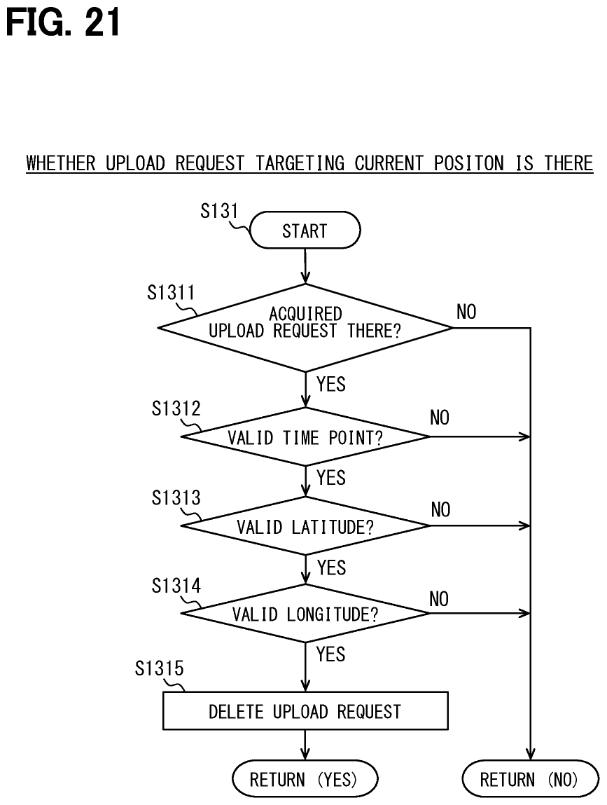

In S13, in detail, processes shown in FIG. 20 are executed. In FIG. 20, in S131, the upload request that is transmitted from the center device 200 and is stored in the predetermined memory is referred, and it is determined whether there is the upload request targeting the current position. In S131, in detail, processes shown in FIG. 21 are executed.

In FIG. 21, in S1311, it is determined whether there is the acquired upload request. When the determination in S1311 is No, the determination in S131 is No. The process returns to FIG. 20. When the determination in S1311 is Yes, the process shifts to S1312.

In S1312, it is determined whether the current time point is the valid time point. Specifically, the upload request is referred, and it is determined whether the current time point is between the target time point lower limit and the target time point upper limit. When this determination is No, the determination in S131 is No. The process returns to FIG. 20. When the determination in S1312 is Yes, the process shifts to S1313.

In S1313, it is determined whether the current latitude is the valid latitude. Specifically, the upload request is referred, and it is determined whether the current latitude is between the target latitude lower limit and the target latitude upper limit. When this determination is No, the determination in S131 is No. The process returns to FIG. 20. When the determination in S1313 is Yes, the process shifts to S1314.

In S1314, it is determined whether the current longitude is the valid longitude. Specifically, the upload request is referred, and it is determined whether the current longitude is between the target longitude lower limit and the target longitude upper limit. When this determination is No, the determination in S131 is No. The process returns to FIG. 20. When the determination in S1314 is Yes, the process shifts to S1315.

In S1315, the upload request temporarily stored in the predetermined memory is deleted. Accordingly, the determination in S131 is Yes, the process returns to FIG. 20.

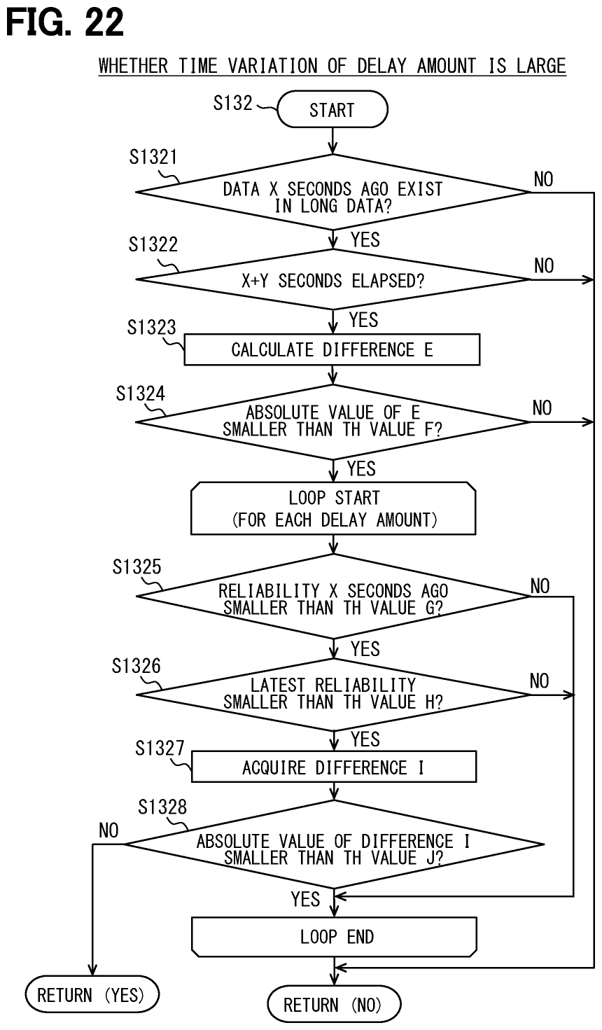

The description is returned to FIG. 20. When the determination in S131 is Yes, the determination in S13 is Yes. The process returns to FIG. 13. When the determination in S131 is No, the process shifts to S132. In S132, it is determined whether the time variation in the delay amount is large. This is because the delay amount may rapidly vary in a short time due to the climate or the like, and, in such a case, it is necessary to upload a large number of data. In S132, in detail, processes shown in FIG. 22 are executed.

In FIG. 22, in S1321, it is determined whether the correction information log data includes log data X seconds ago. The X is a positive integer. When the determination in S1321 is No, the determination in S132 is No. The process returns to FIG. 20. When the determination in S1321 is Yes, the process shifts to S1322.

In S1322, it is determined whether X+Y seconds or more have elapsed since the download data was acquired last A time point when the download data was acquired last is an “acquisition time point of latest download data correction information” of the correction information log data. The Y is a positive integer. When the determination in S1322 is No, the process of FIG. 22 ends. When the determination in S1322 is Yes, the process shifts to S1323.

In S1323, a difference between a position corresponding to the correction information X seconds ago and the current position is calculated. The position corresponding to the correction information X seconds ago is the latitude and the longitude of the log data X seconds ago in the correction information log data. This difference E is the Euclidean distance. When the determination in S1323 is No, the process in FIG. 22 ends. When the determination in S1323 is Yes, the process shifts to S1324.

In S1324, it is determined whether the absolute value of the difference E is smaller than a threshold value F. When the determination in S1324 is No, the process of FIG. 22 ends. When the determination in S1324 is Yes, a loop of S1325 and subsequent processes is executed, in other words, a group of S1325 and the subsequent processes is repeatedly executed. The reason for executing the processes from S1321 to S1324 is as follows.

The correction information varies depending on the position. Therefore, in a case where the positioning device 100 has moved a large distance in a short time, even when a large time variation is observed, it cannot be determined whether the uploading is necessary. Therefore, the processes from S1321 to S1324 are executed, and it is determined whether the positioning device 100 have not moved a large distance in a short time. Accordingly, the Y seconds are set to a value meaning a short time. The threshold value F is set to a value enabling determination of whether the positioning device 100 has moved a large distance. The X seconds is set to a value meaning the latest data.

S1325 to S1328 are executed for each delay amount and each reliability in the correction information estimation value. In S1325, it is determined whether the reliability with respect to the delay amount estimated X seconds ago is smaller than a threshold value G. The threshold value G is a value for determining whether the reliability indicates that the precision is good, and the threshold value G is a positive real number. When the reliability is higher than the threshold value G, it means that the precision is poor. When the precision is poor, the size of time variation due to an atmospheric delay amount and the ionospheric delay amount cannot be determined based on a difference I of the delay amount X seconds ago in S1328 described later. Therefore, this determination in S1325 is performed. When the determination in S1325 is No, the process for the currently targeted delay amount ends. When the determination in S1325 is Yes, the process shifts to S1326.

In S1326, it is determined whether the reliability with respect to the latest delay amount in the correction information estimation value is smaller than a threshold value H. The threshold value H is a value for determining whether the reliability indicates that the precision is good, and is a positive real number. The reason for performing this determination is same as the reason for performing the determination in S1325. When the determination in S1326 is No, the process for the currently targeted delay amount ends. When the determination in S1326 is Yes, the process shifts to S1327.

In S1327, the difference I (that is, the variation amount with the passage of time) between the delay amount X seconds ago and the latest delay amount is calculated. In S1328, it is determined whether the difference I calculated in S1327 is smaller than a threshold value J. The threshold value J is a positive real number determined for each delay amount. The threshold value J is a value for determining whether the difference I indicating the delay amount variation is variation of the delay amount that may normally occur in a short time.

When the determination in S1328 is Yes, the process for the currently targeted delay amount ends. When the determination in S1328 is No, the determination in S132 is Yes, that is, it is determined that the correction information estimation value should be uploaded, and the process of FIG. 22 ends. Accordingly, when at least one time variation of the delay amount is large, it is determined that the correction information estimation value should be uploaded. On the other hand, for all the delay amounts, when the determination in S1328 is Yes, the determination in S132 is No, and the process of FIG. 22 ends.

The description is returned to FIG. 13. When the determination in S13 is No, the process shifts to S15. When the determination in S13 is YES, the process shifts to S14. In S14, the upload data shown in FIG. 5 is generated, and the upload data is uploaded to the center device 200.

In S15, the correction information estimation data including the correction information estimation value is generated, and is added to the correction information log data. In S16, the current time point and the current position are transmitted to the application.

(Comparison Process with Other Device in Periphery)

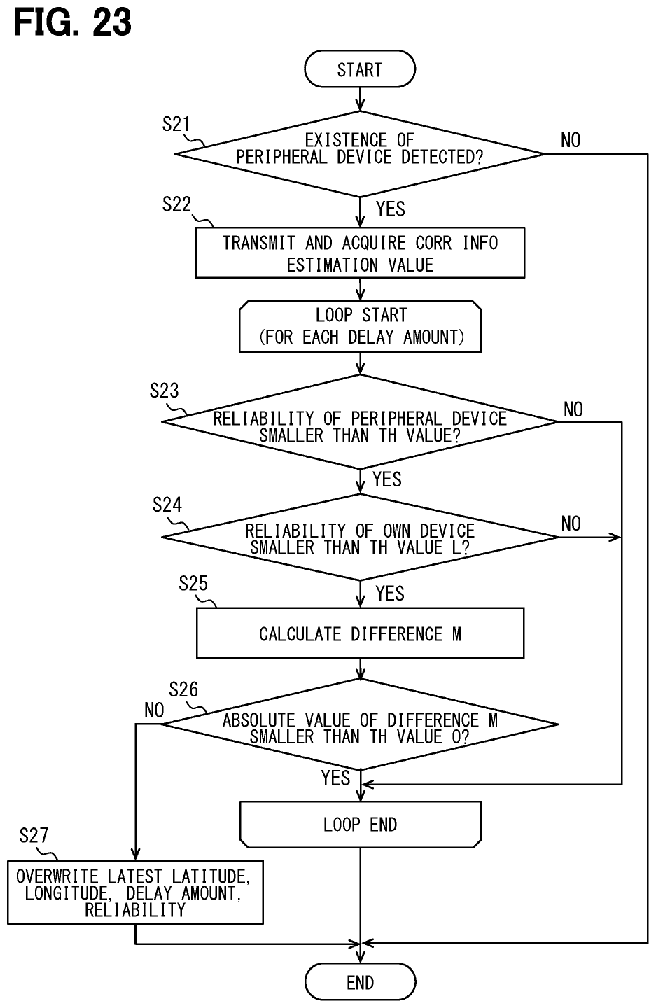

FIG. 23 shows processes executed by the calculator 160 of the positioning device 100 in parallel with those of FIG. 12 and FIG. 13. By executing the processes of FIG. 23, the positioning device 100 compares the correction information estimation value stored by the own device with the correction information estimation value stored by the other positioning device 100 existing in peripheral of the own device.

In S21, it is determined whether the presence of the other positioning device 100 (hereinafter, peripheral device) is detected in the periphery of the own device. The periphery can be set to, for example, an area within a radius of several hundred meters centered on the own device. The detection method can be set to position acquisition by communication via the wide area communication portion 110 or the short range communication portion 120, object detection by the autonomous sensor 140 such as the camera, or the LiDAR, or the like. When the determination in S21 is Yes, the process of FIG. 23 ends. When the determination in S21 is Yes, the process shifts to S22.

In S22, the correction information estimation value is transmitted to the peripheral device, and the correction information estimation value stored by the peripheral device is acquired from the peripheral device. The data structure to be transmitted may be same as that of the upload data. When the data is transmitted or received, the short range communication portion 120 may be used and the wide area communication portion 110 may be used.

S23 to S26 are executed for each delay amount. In S23, it is determined whether the reliability acquired from the peripheral device is smaller than a threshold value L. When the determination in S23 is No, the process for the currently targeted delay amount ends. When the determination in S23 is Yes, the process shifts to S24.

In S24, it is determined that the reliability of the own device is smaller than the threshold value L. When the determination in S24 is No, the currently targeted process for the delay amount ends. When the determination in S24 is Yes, the process shifts to S25. When both of the reliability for the delay amount of the own device and the reliability for the delay amount of the peripheral device are not small, it is not possible to precisely determine whether the delay amount is appropriate by comparing the delay amount of the own delay amount with the delay amount acquired from the peripheral device. Therefore, the determination of S23 and S24 is performed.

In S25, a difference M between the delay amount acquired from the peripheral device and the delay amount stored by the own device is calculated. The delay amount depends on the time and the position. In other words, when the time and the position are approximated, the delay amount should be approximated. Accordingly, when this difference M is large, there is a possibility that either the delay amount of the own device or the delay amount of the peripheral device includes the error.

In S26, it is determined whether the absolute value of the difference M is smaller than a threshold value O. When the determination in S26 is Yes, the process for the currently targeted delay amount ends. When the determination in S26 is No, the process shifts to S27.

When the process shifts to S27, the correction information estimation value may include the error. The latitude and the longitude calculated using the correction information estimation value may also include the error. Therefore, in S27, the latest latitude, the latest longitude, all the delay amount in the correction information estimation value, and all the reliability in the correction information estimation value are set to values (For example, Nan values) indicating that the solution is not normal. The reliability is set to a predetermined positive real number. S27 is a process outside the loop. Therefore, when it is determined even one of the delay amounts has the large difference M from that of peripheral device, the latest latitude, the latest longitude, all the delay amount in the correction information estimation value, and all the reliability in the correction information estimation value are set to values indicating that the solution is not normal.

(Process Executed by Center Device)

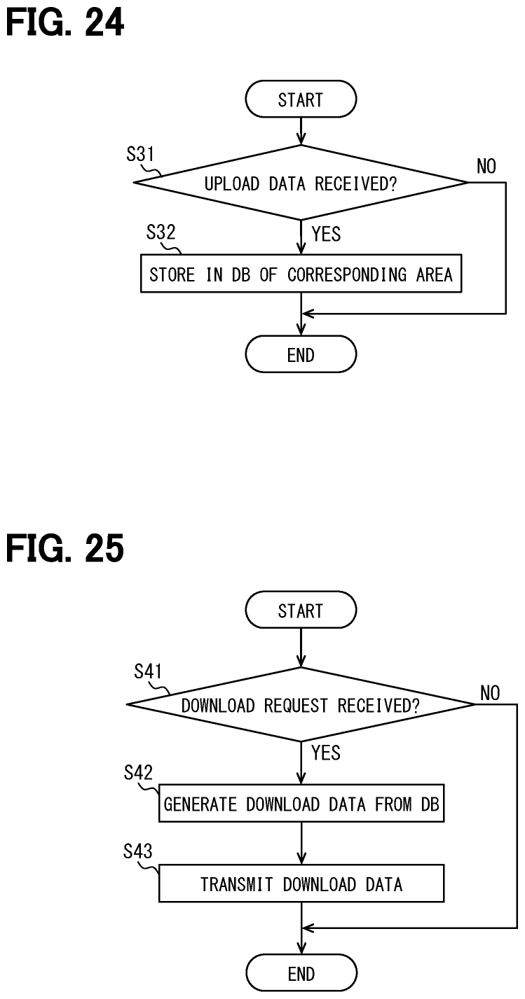

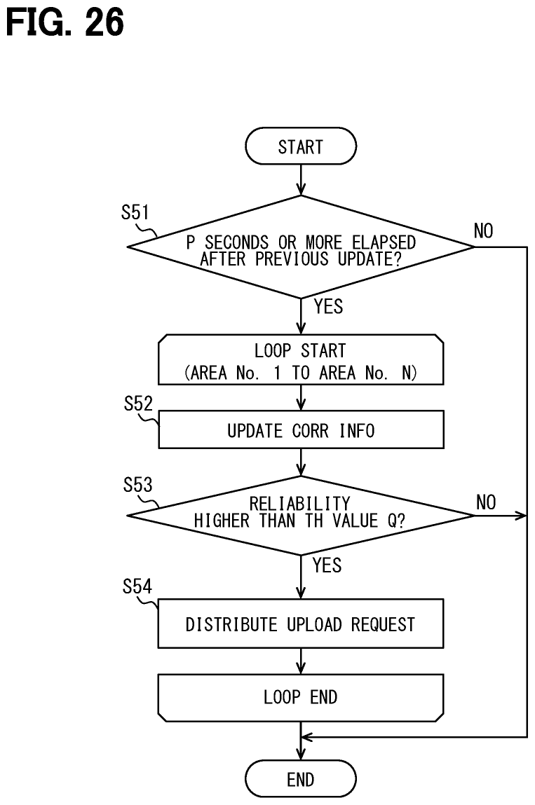

FIG. 24, FIG. 25, and FIG. 26 show processes executed by the calculator 230 of the center device 200. The center device 200 repeatedly executes each of the processes shown in FIG. 24, FIG. 25, and FIG. 26 in parallel at a predetermined cycle. FIG. 24 shows processes related to the upload data. The processes are executed by the upload data processing portion 231.

In S31, it is determined whether the upload data is received. When the determination in S31 is No, the process of FIG. 24 ends. When the determination in S31 is Yes, the process shifts to S32. In S32, when an outlier process is executed on the received upload data. When the correction information estimation value in the received upload data is not an outlier, the correction information database is updated based on the received upload data. When the correction information database is updated, the ID is assigned to the received upload data.

As shown in FIG. 10, in the correction information database, the upload data is saved for each area. By deciding the area including the latitude and the longitude that are in the upload data received at this time, a location to save the upload data received this time is decided.

FIG. 25 shows a process related to the download data. The process is executed by the download data generation portion 233. In S41, it is determined whether the download request is received. When the determination in S41 is No, the process of FIG. 25 ends. When the determination in S41 is Yes, the process shifts to S42.

In S42, the download data is generated based on the download request. The download request has the structure shown in FIG. 7, and includes the latitude and the longitude. Based on the latitude and the longitude, the saved correction information in accordance with the area having the latitude and the longitude is extracted from the correction information database. The download data shown in FIG. 6 is generated. In S43, the download data generated in S42 is transmitted from the wide area communication portion 210 to the positioning device 100 that has transmitted the download request. FIG. 26 shows processes related to the upload request. S51 and S52 are executed by the database upload portion 232. S53 and S54 are executed by the upload request generation portion 234.

In S51, it is determined whether P seconds or more have elapsed since the correction information for distribution was updated last time. The P seconds is an update cycle, and is appropriately set. When the determination in S51 is No, the process of FIG. 26 ends. When the determination in S51 is Yes, the process shifts to S52.

S52 to S54 are executed for each area illustrated in FIG. 11. In S52, the distribution correction information stored in the correction information database is updated. The correction information for distribution is updated based on the upload data in the upload data log. For example, the valid period is decided based on the current time point, each delay amount and each reliability in the upload data uploaded within the valid period are averaged for each type of the reliability and the delay amount, and thereby the correction information for the distribution is updated. The average may be a simple average, or may be a weighted average in which the newer the time, the heavier the weight. Together of the weighted average using the weight depending on the time, or instead of that, a weighted average in which the weight becomes heavier toward the center of the area may be performed.

In S53, it is determined whether the reliability after the update is higher than the threshold value Q. Here, the reliability may be the average value of all the reliability or any one of the reliability. When the determination in S53 is No, the process of FIG. 26 ends. When the determination in S53 is Yes, the process shifts to S54. In S54, the upload request requesting the correction information for the corresponding area is generated and distributed.

In the present embodiment described above, the positioning device 100 includes the positioning calculator 161. The positioning calculator 161 performs the positioning calculation with use of the observation equation including the tropospheric delay amount and the ionospheric delay amount as parameters, and obtains the estimation values of these delay amounts (S1001). The correction information estimation value including the estimation value is transmitted to the center device 200 together with the position where the correction information estimation value is obtained (S14).

Since the positioning device 100 can be used in a moving object, unlike the electronic reference point, the positioning device 100 can be mounted in the moving body such as the vehicle 2 requiring the positioning and can be used for sequentially positioning the position of the moving object. Therefore, the number of positioning devices 100 can be easily set to be higher than the number of electronic reference points. By increasing the number of positioning devices 100, it may be possible to increase the number of places for observing the tropospheric delay amount and the ionospheric delay amount. When the number of places for observing the tropospheric delay amount and the ionospheric delay amount can be increased, the tropospheric delay amount and the ionospheric delay amount can be updated for each narrower area. Accordingly, it may be possible to provide the highly precise positioning while preventing the number of electronic reference points from increasing.

In the present embodiment, the wide area communication portion 210 of the center device 200 and the wide area communication portion 110 of the positioning device 100 communicate with each other via the base station 6 and the public communication network 7, and the download data including the correction information is distributed. Thereby, as compared with a case where quasi-zenith satellite distributes the correction information, the limitation on the amount of data for distribution of the correction information is relaxed. In this respect as well, it may be possible to update the tropospheric delay amount and the ionospheric delay amount for each narrower area.

When the correction information estimation value is uploaded, the positioning device 100 does no always upload the upload data. The positioning device 100 determines whether the uploading is necessary (S13). Thereby, it may be possible to reduce the communication amount of the positioning device 100 while securing the upload data necessary for the center device 200 to distribute the precise correction information.

The positioning device 100 stores the reliability for each of the tropospheric delay amount and the ionospheric delay amount, and determines whether it is necessary to download the correction information based on this reliability (S5). Thereby, it may be possible to reduce the communication amount of the positioning device 100 while maintaining the positioning precision.

The positioning device 100 includes the position estimation portion 163 that estimates the position of the own device with use of the autonomous sensor 140 and the verification portion 164. The verification portion 164 compares the current position estimated by the position estimation portion 163 with the current position calculated by the positioning calculator 161, and determines whether the current position calculated by the positioning calculator 161 is correct (S12). As a result of the verification, when it is determined that the current position calculated by the positioning calculator 161 is not correct (S1204), the current position and the delay amount in the correction information estimation value are set to the values indicating that the solutions are not normal. Thereby, it may be possible to prevent the incorrect delay amount from being uploaded while preventing the control based on the incorrect current position from being executed.

The positioning device 100 calculates the difference M between the delay amount calculated by the own device and the delay amount calculated by the peripheral device. When the difference M is equal to or higher than the threshold value O (S26: Yes), the current position calculated by the positioning calculator 161 and the delay amount are set to be not normal solutions (S27). Thereby, also, it may be possible to prevent the incorrect delay amount from being uploaded while preventing the control based on the incorrect current position from being executed.

Although the embodiment has been described above, the disclosed technology is not limited to the above-described embodiment, and the following modifications are included in the disclosed range, and various modifications can be made without departing from the gist except as described below. In the following description, elements having the same reference numerals as those used so far are the same as elements having the same reference numerals in the previous embodiments, except when specifically mentioned. When only a part of the configuration is described, the embodiment described above can be applied to other parts of the configuration.

(First Modification)

In the embodiment, the tropospheric delay amount and the ionospheric delay amount are shown as the correction information. However, the correction information includes an satellite orbit error and a satellite timepiece error, and the current position may be calculated by correcting these errors. The satellite orbit error and the satellite timepiece error do not depend on the positioning location. That is, the satellite orbit error and the satellite timepieces error are not the location dependence delay amount. Accordingly, the satellite orbit error and the satellite timepiece error may be observed by one device. For example, the satellite orbit error and the satellite timepiece error may be observed by the positioning device 100 provided on the stationary object. As described in Patent Literature 2 of JP 2011-112576 A, the center device may calculate the satellite orbit error and the satellite timepiece error based on the satellite signal collected at the electronic reference point. Patent Literature 2 is incorporated herein by reference.

(Second Modification)

Although the tropospheric delay amount and the ionospheric delay amount are corrected in the embodiment, only the tropospheric delay amount may be corrected. Although the ionospheric delay amount in the L1 band is corrected in the embodiment, the ionospheric delay amount in other bands may be corrected in addition to that in the L1 band or instead of that in the L1 band.

(Third Modification)

The positioning device 100 may have a configuration that can be carried by a person who rides a vehicle.

(Fourth Modification)

The base station 6 may be able to communicate with the short range communication portion 120, and the short range communication portion 120 of the positioning device 100 may be able to communicate with the center device 200.

(Fifth Modification)

In FIG. 20, only one of S131 and S132 may be determined. The determination order of S131 and S132 may be exchanged.

(Sixth Modification)

In FIG. 13, the process in S12 may be omitted. When the process in S12 is omitted, there is a possibility that the positioning device 100 uploads erroneous correction information to the center device 200. However, the center device 200 can normally acquire the correction information from a large number of positioning devices 100. When the center device 200 can acquire the correction information from a large number of positioning devices 100, the reduction of the correction information for the distribution due to no process in S12 is low. Therefore, the process in S12 may be omitted. When the process in S12 is omitted, there is advantage that the positioning device 100 does not need the autonomous sensor 140 and the high precision map.

(Seventh Modification)

The storage medium for storing the program executed by the CPU is not limited to the ROM but may be stored in the non-transitional substantive recording medium. For example, the program may be stored in the flash memory. In addition, a part or all of the functions of the calculators 160 and 230 may be realized by using one or more ICs (in other words, as hardware). In addition, a part or all of the functions of the calculators 160 and 230 may be realized by a combination of software execution by the CPU and hardware components.

It is noted that a flowchart or the process of the flowchart in the present disclosure includes multiple steps (also referred to as sections), each of which is represented, for instance, as S1. Further, each step can be divided into several sub-steps while several steps can be combined into a single step.

In the above, the embodiment, the configuration, and the aspect of the positioning system, the positioning device, and the center device according to the present disclosure are exemplified. However, the present disclosure is not limited to every embodiment, every configuration and every aspect related to the present disclosure that are exemplified. For example, embodiments, configurations, and aspects obtained from an appropriate combination of technical elements disclosed in different embodiments, configurations, and aspects are also included within the scope of the embodiments, configurations, and aspects of the present disclosure.

1. A positioning system comprising:
a plurality of positioning devices: and
a center device configured to communicates with each of the plurality of positioning devices,
wherein:
at least one positioning device among the plurality of positioning devices is usable at a moving body, and includes:
a positioning calculator configured to
calculate a location dependence delay amount and a propagation distance as a convergence value of an observation equation including, as a parameter, the propagation distance and the location dependence delay amount including at least one of a tropospheric delay amount or an ionospheric delay amount and
calculate a current position of the at least one positioning device among the plurality of positioning devices based on the propagation distance; and
a positioning communication portion configured to transmit the location dependence delay amount calculated by the positioning calculator to the center device together with a position of the at least one positioning device at a time when the positioning calculator calculates the location dependence delay amount; and
the center device includes:
an update portion configured to update a distribution location dependence delay amount based on the location dependence delay amount transmitted by the positioning device; and
a distribution communication portion configured to transmit the distribution location dependence delay amount updated by the update portion to at least one of the plurality of positioning devices.

2. The positioning system according to claim 1, wherein:
the center device is placed on ground; and
the distribution communication portion is configured to transmit the distribution location dependence delay amount to the positioning device via a base station on the ground.

3. The position system according to claim 1, wherein:
each of the plurality of positioning devices further includes an uploaded determiner configured to determine whether the location dependence delay amount calculated by the positioning calculator is to be uploaded to the center device.

4. The positioning system according to claim 3, wherein:
the uploaded determiner determines that the location dependence delay amount is to be uploaded to the center device when the center device transmits an upload request.

5. The positioning system according to claim 3, wherein:
the upload determiner determines that the location dependence delay amount is to be uploaded to the center device when a variation amount with passage of time of the location dependence delay amount is higher than a threshold value.

6. The positioning system according to claim 1, further comprising:
a download request portion configured to request the center device to transmit the distribution location dependence delay amount.

7. The positioning system according to claim 6, wherein:
the download request portion requests the center device to transmit the distribution location dependence delay amount when determining that a reliability of the location dependence delay amount for calculation by the calculator is higher than a threshold value.

8. The positioning system according to claim 1, wherein:
the positioning device is mounted on a moving body; and
the positioning system further includes a position estimation portion configured to estimate a current position based on a detection value detected by an autonomous sensor mounted on the moving body, and
a verification portion configured to
verify whether the location dependence delay amount calculated by the positioning calculator is correct based on comparison between the current position estimated by the position estimation portion and the current position calculated by the positioning calculator and
set the location dependence delay amount calculated by the positioning system and the current position calculated by the positioning calculator to a value indicating that a solution is not normal when determining that the location dependence delay amount is not correct.

9. The positioning system according to claim 1, wherein:
the positioning calculator is configured to
acquire the location dependence delay amount calculated by a difference positioning device existing in a periphery, and
set the location dependence delay amount calculated by the positioning calculator to a value indicating that a solution is not normal when a difference between the location dependence delay amount calculated by an own device and the location dependence delay amount calculated by the different positioning device is equal to or higher than a threshold value.

10. A positioning device that is usable at a moving body, the positioning device comprising:
a positioning calculator configured to
calculate a location dependence delay amount and a propagation distance as a convergence value of an observation equation including, as a parameter, the propagation distance and the location dependence delay amount including at least one of a tropospheric delay amount or an ionospheric delay amount and
calculate a current position based on the propagation distance; and
a positioning communication portion configured to transmit the location dependence delay amount calculated by the positioning calculator to the center device together with a position at a time when the positioning calculator calculates the location dependence delay amount.

11. A center device configured to communicate with a plurality of positioning devices, the center device comprising:
an update portion configured to update a distribution location dependence delay amount based on a location dependence delay amount including at least one of a tropospheric delay amount transmitted by the positioning device and an ionospheric delay amount transmitted by the positioning device; and
a distribution communication portion configured to transmit the distribution location dependence delay amount updated by the update portion to at least one of the plurality of positioning devices.
